(19) United States
(12) Patent Application Publication
(10) Pub. No.: US 2011/0008652 A1
(43) Pub. Date: Jan. 13, 2011

(54) SECONDARY BATTERY

(75) Inventors: Sangjoo LEE, Yongin-si (KR); Heuisang YOON, Yongin-si (KR); Woochul KIM, Yongin-si (KR); Woonseong BAEK, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Yongin-si (KR)

(21) Appl. No.: 12/819,148

(22) Filed: Jun. 18, 2010

(30) Foreign Application Priority Data
Jul. 10, 2009 (KR) 10-2009-0063212

(51) Int. Cl. H01M 10/42

(52) U.S. Cl. 429/7

(57) ABSTRACT

A secondary battery is disclosed. The secondary battery comprises a bare cell, a protective circuit module (PCM) comprising a circuit board to control charge and discharge of the bare cell, a connection member electrically connecting the bare cell to the PCM, and a coupling screw coupling the connection member with the bare cell. The circuit board includes a screw hole through which the coupling screws pass.

### CROSS-REFERENCE TO RELATED APPLICATION

This application claims priority to and the benefit of Korean Patent Application No. 10-2009-0063212 filed on Jul. 10, 2009, the entire content of which is incorporated herein by reference.

### BACKGROUND

1. Field

The present invention relates to a secondary battery.

2. Description of the Related Technology

Portable electronic devices are currently in widespread use due to rapid developments in the communication computer industry. Typically, a rechargeable secondary battery is used as a power source for the portable electronic device.

Currently, a pack-type battery is widely used as the secondary battery. In the pack-type battery, a bare cell that provides electric energy and a protective circuit module (PCM) for stably controlling charge and discharge are combined into a single unit.

For the pack-type secondary battery, good workability and excellent electrical connection in coupling the PCM and the bare cell are typically required.

### SUMMARY

Embodiments of the present invention provide a secondary battery exhibiting excellent workability during manufacturing.

Embodiments of the present invention also provide a secondary battery having an excellent electrical connection.

In accordance with an embodiment, a secondary battery comprises: a bare cell; a protective circuit module comprising a circuit board to control charge and discharge of the bare cell; a connection member electrically connecting the bare cell to the protective circuit module; and a coupling screw coupling the connection member with the bare cell, wherein the circuit board includes a screw hole through which the coupling screw passes.

The connection member comprises a bare cell connector contacting the bare cell, and the secondary battery further comprises an elastic member positioned between the circuit board and the bare cell connector. In this case, the elastic member may be a compression coil spring. The compression coil spring may be fitted around the coupling screw and both ends of the compression coil spring contact the bare cell connector of the connection member and the circuit board, respectively. According to an embodiment, the connection member further comprises a circuit board connector that contacts the circuit board, and the elastic member is positioned in an outer side than the circuit board connector in a longitudinal direction of the circuit board.

According to an embodiment, the connection member comprises a bare cell connector that contacts the bare cell and a supporting rib extended from the bare cell connector toward the circuit board so that ends of the supporting rib contacts the circuit board.

According to an embodiment, the head of the coupling screw extends from the circuit board and protrudes toward an opposite side of the bare cell, and the secondary battery may further include a top case covering the circuit board and having an insertion groove, into which a part of the head of the coupling screw is inserted. There may be two coupling screws, and two insertion grooves may be provided to correspond to the respective coupling screws. The secondary battery may further include an adhesive coupling the coupling screw with the insertion groove.

According to an embodiment, the connection member comprises a coupling hole through which a body having threads of the coupling screw passes, and the coupling hole comprises a plurality of coupling flanges formed on an inner circumference thereof and engaged with the threads of the coupling screw.

The bare cell may include an electrode assembly, a can accommodating the electrode assembly and having an opening, and a cap plate sealing the opening of the can, and having internal threads coupled with the coupling screw. In this case, a portion of the cap plate where the internal threads are formed may be thicker than other portions of the cap plate.

The connection member may include a circuit board connector that contacts the circuit board, and the screw hole may be positioned on a side more external than the circuit board connector in a longitudinal direction of the circuit board.

According to an embodiment, the above described aspects of the present invention may be achieved. In detail, according to the present invention, since the coupling screws are inserted into the screw hole formed in the circuit board, the coupling screws may be correctly fastened so that workability improves.

In addition, according to an embodiment, since the bare cell connection unit of the connection member is pushed by the elastic member, an excellent electric connection state is maintained.

Then, according to an embodiment, since the heads of the coupling screws are inserted into the grooves formed in the top case, the coupling state of the top case is reinforced and it is possible to prevent the top case from being twisted.

### BRIEF DESCRIPTION OF THE DRAWINGS

Aspects, features and advantages of embodiments of the present invention will be more apparent from the following detailed description in conjunction with the accompanying drawings, in which:

FIG. 1 is a perspective view illustrating a secondary battery according to an embodiment of the present invention;

FIG. 2 is an exploded perspective view illustrating the secondary battery of FIG. 1;

FIG. 3 is a sectional view taken along the line I-I of the secondary battery of FIG. 1;

FIG. 4 is a partial sectional view illustrating the enlarged periphery of the first coupling screw of FIG. 3;

FIG. 5 is a plan view illustrating the first connection member of FIG. 2;

FIG. 6 is a sectional view illustrating a secondary battery according to another embodiment of the present invention; and

FIG. 7 is a perspective view illustrating the first connection member of FIG. 6.

### DETAILED DESCRIPTION

Hereinafter, embodiments of the present invention will be described in detail with reference to the accompanying drawings.

A secondary battery according to an embodiment of the present invention will be described in detail.

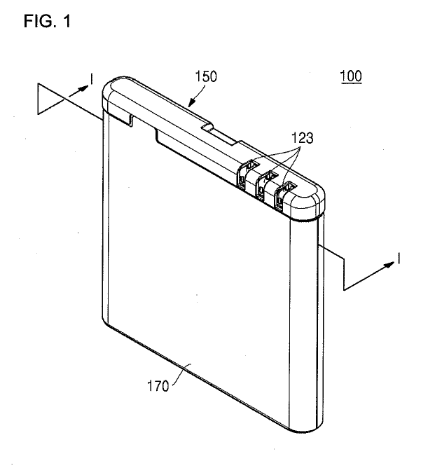

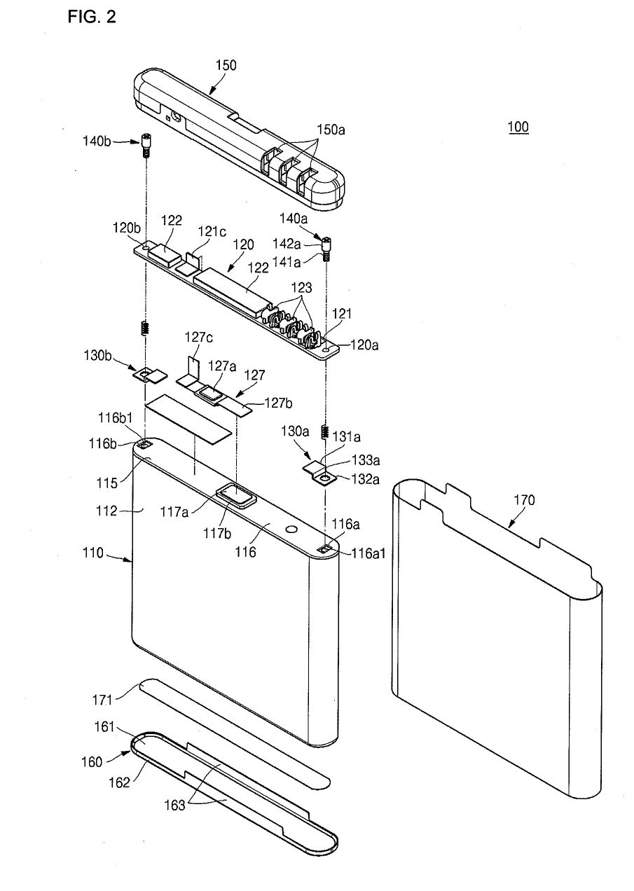

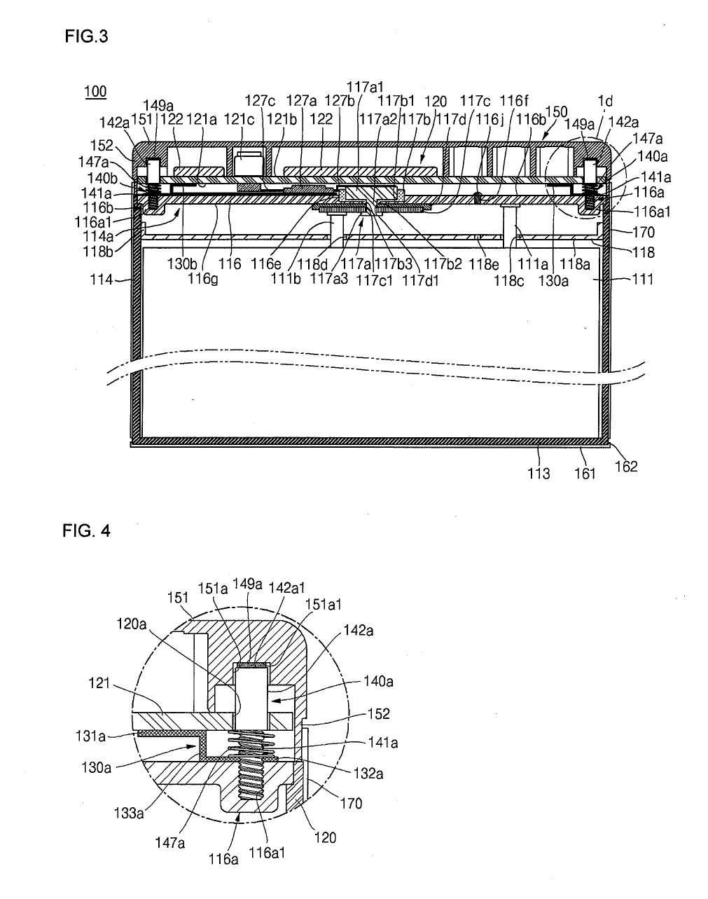

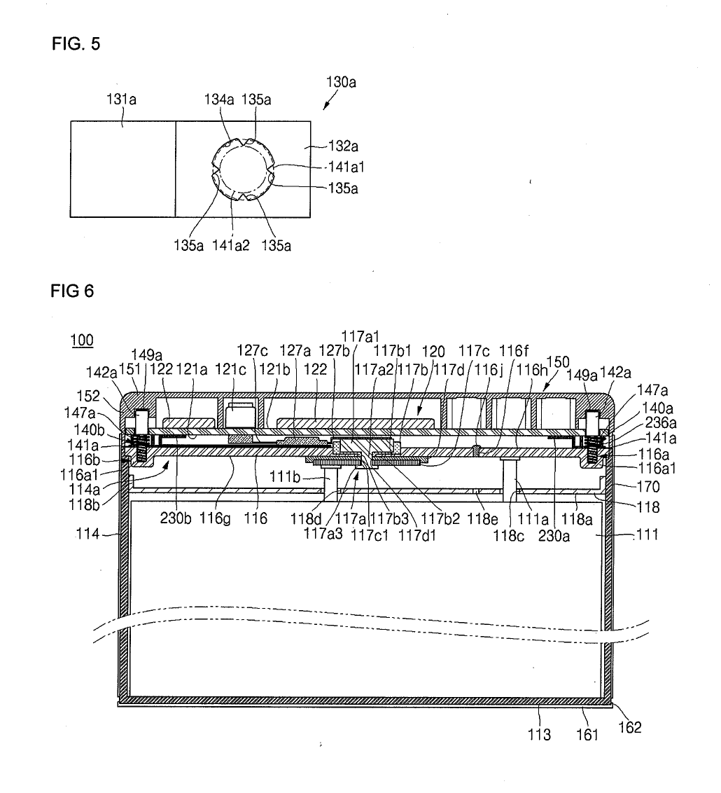

FIGS. 1 to 5 are views illustrating a secondary battery according to an embodiment of the present invention. Specifically, FIG. 1 is a perspective view of a secondary battery according to an embodiment. FIG. 2 is an exploded perspective view illustrating the secondary battery of FIG. 1. FIG. 3 is a sectional view taken along the line I-I of the secondary battery of FIG. 1. FIG. 4 is a partial sectional view illustrating the enlarged periphery of a first coupling screw of FIG. 3. FIG. 5 is a plan view illustrating a first connection member of FIG. 2.

Referring to FIGS. 1 to 5, a secondary battery 100 according to an embodiment may include a bare cell 110, a protective circuit module (PCM) 120, a positive temperature coefficient (PTC) element 127, first and second connection members 130a and 130b, first and second coupling screws 140a and 140b, first and second elastic members 147a and 147b, a top case 150, a bottom case 160, and a label 170. The secondary battery 100 can stably charge and discharge the bare cell 110 using the PCM 120.

The bare cell 110 may include an electrode assembly 111, a can 112, a cap assembly 115, and an insulation case 118. The bare cell 110 can stores electric energy supplied from a charger (not shown) and supply the stored electric energy to an external load (not shown).

The electrode assembly 111 may include a first electrode plate (not shown), a second electrode plate (not shown), and a separator (not shown) interposed between the two electrode plates. The electrode assembly 111 may be wound into a jelly-roll type. A first conductive electrode tab 111a may be coupled with the first electrode plate. The first electrode tab 111a may be electrically connected to the cap assembly 115. A second conductive electrode tab 111b may be coupled with the second electrode plate. The second electrode tab 111b is electrically connected to the cap assembly 115. In the illustrated embodiment, the first electrode plate may be a positive electrode plate and the second electrode plate may be a negative electrode plate. Therefore, the first electrode tab 111a may become a positive electrode tab and the second electrode tab 111b may become a negative electrode tab. However, embodiments of the present invention are not limited to the above. Unlike in the above, when the first electrode plate becomes the negative electrode plate and the second electrode plate becomes the positive electrode plate, the first electrode tab 111a may become the negative electrode tab and the second electrode tab 111b may become the positive electrode tab.

The can 112 can include a thin bar shaped bottom plate 113 and side walls 114 extended from edges of the bottom plate 113. The can 112 can provide a space that accommodates the electrode assembly 111 and the insulation case 118. The internal region at the ends of the side walls 114 may be opened to form an opening 114a that can provide an entrance for entry of the electrode assembly 111 and the insulation case 118. The shape and size of the opening 114a may be approximately the same as the shape and size of the bottom plate 113. The opening 114a may be sealed by the cap assembly 115. The can 112 may be made of a light and flexible metal plate, such as aluminum or an aluminum alloy by deep drawing.

The cap assembly 115 can include a cap plate 116, an electrode terminal 117a, an insulation gasket 117b, a terminal plate 117c, and an insulation plate 117d. The cap assembly 115 can seal the opening 114a of the can 112 to provide the two terminals to the bare cell 110.

The cap plate 116 can include first and second coupling units 116a and 116b, a terminal through hole 116e, and an electrolyte injection hole 116f. The cap plate 116 can be a metal plate having the size and shape corresponding to the opening 114a of the can 112 and can extend in one direction like the bottom plate 113. The cap plate 116 can be seated on the top ends of the side walls 114 of the can 112 and can be coupled with the side walls 114 of the can 112, for example, by laser welding, to seal the opening 114a. The cap plate 116 can include a first surface 116g that faces the internal space of the can 112 and a second surface 116h opposite to the first surface 116g and exposed to the outside of the can. The first electrode tab 111a of the electrode assembly 111 may be connected to the first surface 116g by, for example, laser welding, so that the cap plate 116 can serve as the first terminal of the bare cell 110.

The first coupling unit 116a and the second coupling unit 116b may be positioned at both longitudinal ends of the cap plate 116. The first connection member 130a and the second connection member 130b may be coupled to the first coupling unit 116a and the second coupling unit 116b, respectively.

The first coupling unit 116a may include a first internal thread 116a1 formed in the second surface 116h of the cap plate 116. The first internal thread 116a1 may extend approximately perpendicular to the second surface 116h of the cap plate 116. The first internal thread 116a1 can provide a space, in which the first coupling screw 140a is engaged with the first internal thread 116a1. In the first coupling unit 116a, the first surface 116g of the cap plate 112 can protrude such that the first internal thread 116a1 is sufficiently deep. Therefore, the first surface 116g can be thicker than a periphery.

According to embodiments, the second coupling unit 116b is the same as the first coupling unit 116a. The second connection member 130b may be coupled with the second coupling unit 116b by the second coupling screw 140b.

The terminal through hole 116e may be positioned in the center of the cap plate 116. The terminal through hole 116e may provide a passage through which the electrode terminal 117a may pass.

The electrolyte injection hole 116f may be positioned between the terminal through hole 116e and the first coupling unit 116a. The electrolyte injection hole 116f may provide a passage for injecting electrolyte into the can 112 and be sealed by a stopper 116j after the electrolyte is injected.

The electrode terminal 117a may include a body 117a1 and a connector 117a2 extended from the body 117a1. The electrode terminal 117a may be electrically connected to the second electrode tab 111b of the electrode assembly 111 and be electrically insulated from the cap plate 116 by the insulation gasket 117b so that the electrode terminal 117a can serve as the second terminal of the bare cell 110.

The body 117a1 may be positioned on the second surface 116h of the cap plate 116. The body 117a1 may be exposed from the bare cell 110 to the outside and be electrically connected to the PCM 120.

The connector 117a2 may extend from the body 117a1 and pass through the terminal through hole 116e of the cap plate 116 so that an end 117a3 of the connector 117a2 is positioned in the internal space of the can 112. The end 117a3 of the connector 117a2 may be expanded by caulking and be coupled with the cap plate 116, the electrode terminal 117a, the insulation gasket 117b, the terminal plate 117c, and the insulation plate 117d.

The insulation gasket 117b can include a seat 117b1, on which the body 117a1 of the electrode terminal 117a is seated, and an insertion portion 117b2 that protrudes from the seat 117b1 to be inserted into the terminal through hole 116e of the cap plate 116. The insulation gasket 117b may be made of an insulation material to electrically insulate the electrode terminal 117a from the cap plate 116. An insertion hole 117b3 that penetrates the seat 117b1 and the insertion portion 117b2 may be formed in the insulation gasket 117b. The insertion hole 117b may provide a passage through which the connector 117a2 of the electrode terminal 117a passes.

The terminal plate 117c may be made of a conductive material such as nickel. The terminal plate 117c may be positioned on the first surface 116g of the cap plate 116 and be coupled with the electrode terminal 117a. The terminal plate 117c may provide an area such that the second electrode tab 111b of the electrode assembly 111 may be sufficiently coupled therewith. The second electrode tab 111b of the electrode assembly 111 may be coupled with the terminal plate 117c, for example, by laser welding. The terminal plate 117c may be electrically insulated from the cap plate 116 by the insulation plate 117d. A first passage hole 117c1, through which the connector 117a2 of the electrode terminal 117a can pass, may be formed in the terminal plate 117c.

The insulation plate 117d may be made of an insulation material. The insulation plate 117d may be positioned between the cap plate 116 and the terminal plate 117c. The insulation plate 117d can electrically insulate the cap plate 116 from the terminal plate 117c. A second passage hole 117d1, through which the connector 117a2 of the electrode terminal 117a can pass, may be formed in the insulation plate 117d.

The insulation case 118 may include a main body 118a and a support 118b extended upward from the edge of the main body 118a. The insulation case 118 may be positioned between the electrode assembly 111 and the cap plate 116 in the can 112. The insulation case 118 can electrically insulate the electrode assembly 111 from the cap plate 116 and prevent the electrode assembly 111 from moving in the can 112.

The main body 118a may be a plate shaped member having approximately the same shape as that of the opening 114a of the can 112, and can include a first electrode tab outlet 118c, a second electrode tab outlet 118d, and an electrolyte inlet 118e. The main body 118a can face the electrode assembly 111 and electrically insulate the electrode assembly 111 from the cap plate 116. The first electrode tab outlet 118c can provide a passage through which the first electrode tab 111a of the electrode assembly 111 may pass. The second electrode tab outlet 118d can provide a passage through which the second electrode tab 111b of the electrode assembly 111 may pass. The electrolyte inlet 118e can provide a passage through which the electrolyte may flow toward the electrode assembly 111.

The support 118b may be a wall extended upward from the edge of the main body 118a. The support 118b can contact the side walls 114 of the can 112 and support the main body 118a. Therefore, the electrode assembly 111 may be prevented from moving in the can 112.

The PCM 120 can include a circuit board 121 and an electric circuit element 122 and an external terminal 123 which may be mounted in the circuit board 121. The PCM 120 can be coupled with the bare cell 110 to control the operation of the secondary battery 100, including charging and discharging.

The circuit board 121 as a printed circuit board (PCB), to which wiring line patterns are printed, may be made in the form of a bar. A first screw hole 120a and a second screw hole 120b may be formed at both longitudinal ends of the circuit board 121. The first screw hole 120a may be positioned to correspond to the first internal thread 116a1 of the cap plate 116. The first coupling screw 140a can pass through the first screw hole 120a. The first screw hole 120a can guide the first coupling screw 140a. The second screw hole 120b may be positioned to correspond to the second thread 116a2 of the cap plate 116. The second coupling screw 140b may pass through the second screw hole 120b. The second screw hole 120b can guide the second coupling screw 140b.

The circuit board 121 can include a first surface 121a and a second surface 121b opposite to the first surface 121a. The first surface 121a may face the cap plate 116 of the bare cell 110 by a distance. The first connection member 130a and the second connection member 130b may be coupled with the first surface 121a at both longitudinal ends of the circuit board 121, for example, by soldering. A conductive pad 121c may be coupled with the second surface 121b of the circuit board 121, for example, by soldering. The PTC element 127 may be connected to the conductive pad 121c.

The electric circuit element 122 can include elements such as a control IC and a charge and discharge switch. The electric circuit element 122 can control the charge and discharge of the secondary battery 100. The electric circuit element 122 may be coupled with the second surface 121b of the circuit board 121, for example, by soldering.

The external terminal 123 may be coupled with the second surface 121b of the circuit board 121 by a method such as soldering. The external terminal 123 may be electrically connected to the external load or the charger.

The PTC element 127 can include a PTC main body 127a, a first lead plate 127b, and a second lead plate 127c. The PTC element 127 can electrically connect the PCM 120 to the electrode terminal 117a that serves as the second electrode of the bare cell 110, and can detect when the bare cell 110 is at high temperature due to overcharge to intercept a circuit.

When the temperature of the PTC main body 127a rises, electric resistance thereof can rapidly rise. The PTC main body 127a may be positioned directly above the cap plate 116 to directly sense the heat generated from the bare cell 110.

The first lead plate 127b can extend from the PTC main body 127b and be coupled with the electrode terminal 117a of the bare cell 110 by, for example, laser welding. Therefore, the first lead plate 127b can electrically connect the PTC main body 127b to the electrode terminal 117a of the bare cell 110.

The second lead plate 127c can extend from the PTC main body 127a and be coupled with the conductive pad 121c of the PCM 120 by, for example, laser welding. Therefore, the second lead plate 127c can electrically connect the PTC main body 127b to the PCM 120.

The first connection member 130a can include a circuit board connector 131a, a bare cell connector 132a, and a connection portion 133a. The first connection member 130a may be made of a conductive material such as nickel to electrically connect the PCM 120 to the cap plate 116 that serves as the first electrode of the bare cell 110. The circuit board connector 131a, the bare cell connector 132a, and the connection portion 133a may be formed by bending a single plate. The first connection member 130a is positioned at one end in the longitudinal direction of the circuit board 121.

The circuit board connector 131a may be made into a planar plate. The circuit board connector 131a may be coupled with the first surface 121a of the circuit board 121 by, for example, soldering, and bring into surface contact with the first surface 121a of the circuit board 121.

The bare cell connector 132a may be made into a planar plate. The circuit board connector 131a may be coupled with the cap plate 116 by the first coupling screw 140a and bring into surface contact with the cap plate 116. A coupling hole 134a may be provided in the bare cell connector 132a. The coupling hole 134a may be positioned to correspond to the first internal thread 116a1 of the cap plate 116. A plurality of coupling flanges 135a engaged with the thread of the first coupling screw 140a may be provided on the inner circumference of the coupling hole 134a. The coupling flanges 135a may be positioned in screw roots 141a2 between screw crests 141a of the threads of the first coupling screw 140a. The coupling flanges 135a may be formed to a smaller thickness than a pitch between the screw crests 141a of the first coupling screw 140a, so that the coupling flanges 135a are smoothly engaged with the threads of the first coupling screw 140a. The coupling flanges 135a may have a thickness of 20% to 90% of the pitch of the threads of the first coupling screw 140a.

TABLE 1

| Sample | Before drop | 50 cycle | 100 cycle | 150 cycle | 200 cycle |
|---|---|---|---|---|---|
| No | IR | IR | IR | IR | IR |
| 1 | 134.5 | 137.4 | 141.5 | 146.5 | 144.3 |
| 2 | 131.5 | 135.7 | 138.7 | 139.2 | 139.4 |
| 3 | 135.5 | 137.1 | 142.4 | 143.5 | 180.0 |
| 4 | 131.7 | 139.2 | 156.0 | 147.1 | 146.7 |
| 5 | 135.0 | 138.4 | 153.0 | 149.0 | 158.0 |
| 6 | 134.2 | 145.6 | 183.0 | 156.0 | 156.5 |
| 7 | 134.0 | 138.8 | 139.2 | 138.6 | 137.3 |
| 8 | 132.0 | 131.3 | 137.4 | 136.1 | 143.0 |
| 9 | 131.5 | 138.5 | 137.0 | 142.0 | 143.1 |
| 10 | 134.8 | 135.6 | 136.5 | 140.2 | 144.2 |
| 11 | 131.8 | 134.8 | 137.8 | 141.8 | 134.8 |
| 12 | 134.8 | 135.8 | 138.5 | 143.8 | 146.6 |

Table 1 shows the results of measurements of IR drop experiments in a case where the first connection member 130a includes the plurality of coupling flanges 135a according to the illustrated embodiment (refer to Sample Nos. 7 to 12 of Table 1) and in a case where the first connection member 130a does not include the coupling flanges 135a (refer to Sample Nos. 1 to 6 of Table 1). As listed in Table 1, the IR data of all of the samples before the drop experiments (refer to the IR data listed under ‘Before drop’) are 131.5 to 135.0, which have little deviation. However, when the drop experiments are carried out a more number of times, such as 50 times, 100 times, 150 times, and 200 times, for the case where the plurality of coupling flanges 135a are not provided in the first connection member 130a, it is understood that the IR values increase and that the difference in IR values for the samples is large.

However, when the coupling flanges 135a are provided in the first connection member 130a, although the number of times of the drop experiments increases, the IR values hardly increase and the difference in IR values for the samples is small.

The connection portion 133a may be in the form of a wall. The upper end of the connection portion 133a may be connected to one end of the circuit board connector 131a, and the lower end of the connection portion 133a may be connected to one end of the bare cell connector 132a. The connection portion 133a can connect the circuit board connector 131a and the bare cell connector 132a that are initially separated from each other.

Since the second connection member 130b can be the same as the first connection member 130a, it will not be described herein. The second connection member 130b may be positioned at the other end opposite to the first connection member 130a positioned at one longitudinal end of the circuit board 121. The bare cell connector 132b of the second connection member 130b may be coupled with the second coupling unit 116b of the cap plate 116 by the second coupling screw 140b.

The first coupling screw 140a may include a body 141a having threads, and a head 142a formed at one end of the body 141a. The first coupling screw 140a may couple the first connection member 130a with the cap plate 116. The body 141a may be engaged with the first internal thread 116a1 of the cap plate 116. The thread formed in the body 141a may be engaged with the coupling flanges 135a formed in the coupling hole 134a of the first connection member 130a to enter the first internal thread 116a1. Therefore, the coupling force between the bare cell connector 132a of the first connection member 130a and the cap plate 166 can be reinforced. The head 142a may be positioned in the first screw hole 120a formed in the circuit board 121 and extend toward the opposite side of the bare cell 110 to protrude from the circuit board 121.

Since the second coupling screw 140b can be the same as the first coupling screw 140a, it will not be described herein. The second coupling screw 140b can couple the second connection member 130b with the cap plate 116.

The first elastic member 147a may be a compression coil spring and positioned between the circuit board 121 and the bare cell connector 132a of the first connection member 130a in a state of being fitted around the first coupling screw 140a. Both ends of the first elastic member 147a may contact the first surface 121a of the circuit board 121 and the bare cell connector 132a of the first connection member 130a, respectively. The first elastic member 147a can press the bare cell connector 132a of the first connection member 130a toward the cap plate 116 of the bare cell 110 to stably maintain an electrical connection between the first connection member 130a and the cap plate 116.

The second elastic member 147b may be a compression coil spring and be positioned between the circuit board 121 and the bare cell connector 132b of the second connection member 130b in a state of being fitted around the second coupling screw 140b. Both ends of the second elastic member 147b can contact the first surface 121a of the circuit board 121 and the bare cell connector 132b of the second connection member 130b, respectively. The second elastic member 147b can press the bare cell connector 132b of the second connection member 130b toward the cap plate 116 of the bare cell 110 to stably maintain an electrical connection between the second connection member 130b and the cap plate 116.

The top case 150 may include a cover plate 151 facing the circuit board 121 and side walls 152 extended from the cover plate 151 and connected to the side walls 114 of the can 112. The top case 150 may be positioned on the bare cell 110 while accommodating the PCM 120 therein. The top case 150 can protect the PCM 120. The top case 150 may have a through hole 150a, through which the external terminal 123 is exposed.

First and second insertion grooves 151a and 151b may be provided in the inner surface of the cover plate 151 of the top case 150 for insertion of the heads 142a and 142b of the first and second coupling screws 140a and 140b. A first adhesive 149a may be formed between the end 142a of the head 142a of the first coupling screw 140a and the end 151a of the first insertion groove 151a. A second adhesive 149b may be formed between the head 142b of the second coupling screw 140b and the second insertion groove 151b. The top case 150 can be firmly coupled with the first and second coupling screws 140a and 140b by the first and second adhesives 149a and 149b. Since the top case 150 can be firmly coupled with the first and second coupling screws 140a and 140b, twisting of the top case 150 by external shock may be prevented.

The bottom case 160 may include a base plate 161 and side walls 162 extended from the edge of the base plate 161. The bottom case 160 may surround the lower side of the bare cell 110 to protect the lower side of the bare cell 110. The base plate 161 may be attached to the bottom plate 113 of the can 112 by a double-sided tape 164. The side walls 162 may surround the lower side of the can 112 to protect the lower side of the side walls 114 of the can 112. Extensions 163 may extend upwardly from the side walls 162.

The label 170 may be attached to the external surface of the bare cell 110 to surround the side walls 114 of the can 112. The label 170 may be formed to surround the side walls 152 of the top case 150 and the extensions 163 of the bottom case 160.

Next, a secondary battery according to another embodiment of the present invention will be described in detail.

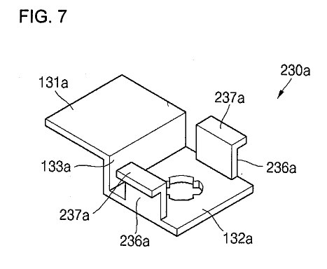

FIGS. 6 and 7 are views illustrating the secondary battery according to another embodiment. FIG. 6 is a sectional view illustrating a secondary battery according to an embodiment. FIG. 7 is a perspective view illustrating the first connection member of FIG. 6. In another embodiment, the same components as the components in the first embodiment are denoted by the same reference numerals. In addition, in another embodiment, description of the same components as the components in the first embodiment will be omitted in order to avoid redundancy. The secondary battery according to another embodiment can include first and second connection members having different structures from the first and second connection members according to the above-mentioned embodiment. The secondary battery according to another embodiment can be the same as the secondary battery according to the embodiment described above, except that the secondary battery according to another embodiment may not include the first and second elastic members described in the above-mentioned embodiment. Therefore, in another embodiment, only the first and second connection members will be described in detail.

Referring to FIGS. 6 and 7, a first connection member 230a may include a circuit board connector 131a, a bare cell connector 132a, a connection portion 133a, and a plurality of supporting ribs 236a. Since the circuit board connector 131a, the bare cell connector 132a, and the connection portion 133a can be the same as the circuit board connector 131a, the bare cell connector 132a, and the connection portion 133a in the above-mentioned embodiment, they will not be described herein. The supporting ribs 236a may extend from the bare cell connector 132a toward the circuit board 121. Contacts 237a contacting the bare cell connector 132a may be formed at the ends of the supporting ribs 236a. The bare cell connector 132a of the first connection member 230a can maintain an excellent connection to the cap plate 166 by the supporting ribs 236a.

Since the configuration and function of the second connection member 230b can be the same as those of the first connection member 230a, it will not be described herein.

Although exemplary embodiments of the present invention have been described in detail above, many variations and modifications of the basic inventive concept described herein as may appear to those skilled in the art will fall within the spirit and scope of the exemplary embodiments of the present invention as defined by the appended claims.

What is claimed is:

1. A secondary battery, comprising:
a bare cell;
a protective circuit module comprising a circuit board to control charge and discharge of the bare cell;
a connection member electrically connecting the bare cell to the protective circuit module; and
a coupling screw coupling the connection member with the bare cell,
wherein the circuit board comprises a screw hole through which the coupling screw passes.

2. The secondary battery of claim 1, further comprising an elastic member positioned between the circuit board and the bare cell connector;
wherein the connection member comprises a bare cell connector contacting the bare cell.

3. The secondary battery of claim 2, wherein the elastic member comprises a compression coil spring.

4. The secondary battery of claim 3, wherein the compression coil spring is fitted around the coupling screw.

5. The second battery of claim 2, wherein both ends of the compression coil spring contact the bare cell connector of the connection member and the circuit board, respectively.

6. The secondary battery of claim 2, wherein the connection member further comprises a circuit board connector that contacts the circuit board, and
the elastic member is positioned on a side more external than the circuit board connector in a longitudinal direction of the circuit board.

7. The secondary battery of claim 1, wherein the connection member comprises:
a bare cell connector that contacts the bare cell; and
a supporting rib extended from the bare cell connector toward the circuit board so that ends of the supporting rib contact the circuit board.

8. The secondary battery of claim 7, wherein the supporting rib comprises a plurality of supporting ribs.

9. The secondary battery of claim 1, wherein a head of the coupling screw extends from the circuit board and protrudes toward an opposite side of the bare cell, and the secondary battery further comprises a top case covering the circuit board and having an insertion groove, into which a part of the head of the coupling screw is inserted.

10. The secondary battery of claim 9, wherein the coupling screw comprises two coupling screws, and
the insertion groove has two insertion grooves to correspond to the respective coupling screws.

11. The secondary battery of claim 9, further comprising an adhesive coupling the coupling screw with the insertion groove.

12. The secondary battery of claim 1, wherein the connection member comprises a coupling hole through which threads of the coupling screw passes, and the coupling hole has a plurality of coupling flanges formed on an inner circumference thereof and engaged with the threads of the coupling screw.

13. The secondary battery of claim 12, wherein the coupling flanges have a thickness that is smaller than a pitch of the threads of the coupling screw.

14. The secondary battery of claim 1, wherein the bare cell comprises:
an electrode assembly;
a can accommodating the electrode assembly and having an opening; and
a cap plate sealing the opening of the can, and having internal threads coupled with the coupling screw.

15. The secondary battery of claim 14, wherein the internal threads are formed on a portion of the cap plate that is thicker than other portions of the cap plate.

16. The secondary battery of claim 1, wherein the connection member comprises a circuit board connector that contacts the circuit board, and
wherein the screw hole is positioned in a side more external than the circuit board connector in a longitudinal direction of the circuit board.

17. A secondary battery, comprising:
a bare cell;
a circuit module;
a first coupling member coupling the bare cell to the circuit module; and
a second coupling member coupling the first coupling member with the bare cell,
wherein the circuit module comprises an opening for the second coupling member to pass through.

18. The secondary battery of claim 17, wherein the first coupling member comprises a bare cell connector that contacts the bare cell and a circuit module connector that contacts a circuit board on the protective circuit.

19. The secondary battery of claim 17, wherein the second coupling member comprises a screw and the opening comprises a screw hole.

20. The secondary battery of claim 17, further comprising a compression member between the circuit module and the bare cell connector.
